(19) United States
(12) Patent Application Publication
(10) Pub. No.: US 2012/0207075 A1
(43) Pub. Date: Aug. 16, 2012

(54) MULTICAST DATA DELIVERY MECHANISM USING PACKET BUNDLING OR FILE DELIVERY FRAMEWORK

(76) Inventors: Thadi M. NAGARAJ, San Diego, CA (US); Rohit SAUHTA, San Diego, CA (US); Joseph BARONE, San Diego, CA (US)

(21) Appl. No.: 13/371,388

(22) Filed: Feb. 10, 2012

Related U.S. Application Data
(60) Provisional application No. 61/443,566, filed on Feb. 16, 2011.

(51) Int. Cl. H04W 4/06; H04H 20/71

(52) U.S. Cl. 370/312

(57) ABSTRACT

Methods, systems and devices enable efficient delivery of UDP packets over broadcast systems to receiver devices. UDP packets may be bundled and embedded within files for transmission over a file delivery framework, to deliver UDP packets over a broadcast network. A broadcast schedule message (BSM) may inform receiver devices of files and UDP packets that will be broadcast at a specified time, as well as describe the files and UDP packets. Files may be transmitted in file delivery pipes, which may be of different bandwidth and data rates. Receiver devices configured according to the embodiments may make use of the BSM message to select the UDP packets to be received based on the service or application to which the UDP packets are associated. Receiver devices activate receiver circuitry to capture the files and the UDP packets contained therein and pass the received files to applications or services requesting the files.

### RELATED APPLICATIONS

This application claims the benefit of priority to U.S. Provisional Application No. 61/443,566, entitled “Multicast data delivery mechanism using packet bundling or file delivery framework” filed Feb. 16, 2011, the entire contents of which are hereby incorporated by reference.

### BACKGROUND

Wireless communication technologies have seen explosive growth over the past few years. This growth has been fueled by wireless services providing freedom of movement to the mobile public, and cutting the tether to hardwired communication systems. As a result of service enhancements, the popularity of wireless services is expected to continue to grow rapidly. A recent addition to wireless communication services has been the ability to broadcast television and other content to receiver devices. Mobile forward-link-only broadcast services allow users to view multimedia programming, such as television shows, as well as receive mobile editions of news, entertainment, sports, business, and other broadcast programming, using mobile receiver devices configured to receive the mobile broadcast transmissions. The growth of multimedia broadcast services represents an attractive communication platform for delivering a wide variety of content in various formats.

### SUMMARY

Various embodiments may provide systems, devices, and methods for utilizing a broadcast based File Delivery Framework (FDF) to deliver datagram packets (e.g., data packets according to User Datagram Protocol (UDP), AppleTalk, NetBIOS, etc.), to applications running on receiver devices. Specifically, various embodiments may provide mechanisms and systems for efficiently delivering datagram packets to receiver device applications by embedding the datagram packets within files, which may carry datagram packets from a variety of sources, and delivering the files over a broadcast system to receiver devices using the FDF service of a broadcast communication network. In particular, the datagram packets may be UDP packets which may be provided by receiver devices to applications running on the devices which expect UDP packets as data inputs. Datagram packets from different content sources may be embedded in a single file for efficient broadcast and reception. Such bundling of different datagram packets (e.g., UDP packets) within conglomerate files for broadcast may be organized according to the type of information or application (e.g., grouping news source UDP packets within a conglomerate news file for broadcast), or according to demographics (e.g., grouping UDP packets for applications of interest to children in a conglomerate file for broadcast), for example. Files and datagram packets for broadcast and/or reception may be advertised in advance by the broadcast network by broadcasting a Broadcast Schedule Message (BSM). BSMs may be transmitted in advance to inform receiver devices of the files and datagram packets that will be broadcast at a specified time in the future. The various embodiments utilize the built in redundancy, error correction and reliability mechanisms provided by the FDF service to deliver datagram packets in a more timely, coherent and effective manner. Receiver devices may use the advertised broadcast times to selectively receive files and access their included datagram packets corresponding to application requests. Applications requesting particular types of datagram packets (e.g., those UDP packets meant for the requesting application) may then receive and utilize the datagram packets as they are received by the receiver devices.

Various embodiments may include a method for delivering UDP packets to a receiver device over a broadcast communication network, which includes receiving in a server of the broadcast communication network UDP packets for transport from a content provider, generating in the server files containing the received UDP packets, the generated files having a file name and containing information regarding the UDP packets contained in the files and communication requirements, scheduling the generated files for transmission via a file data flow within a broadcast transmission, generating a broadcast scheduling message indicating when files will be broadcast within a broadcast scheduling period, information regarding those files, and a scheduled broadcast time window for each file, broadcasting the generated broadcast scheduling message via the broadcast network, and broadcasting the generated files via the file data flow of the broadcast network in accordance with the scheduled broadcast time windows included within the broadcast scheduling message. In an embodiment, the method may further include receiving from an application operating within the receiver device a request to capture UDP packets, the request specifying one or more reception criteria, receiving the broadcast scheduling message in the receiver device, identifying for reception a file containing UDP packets matching the reception criteria based on information in the received broadcast scheduling message, identifying from the broadcast scheduling message the scheduled broadcast time window when a file matching the reception criteria will be broadcast, activating a receiver circuitry of the receiver device at the identified scheduled broadcast time window for the identified file, receiving in the receiver device the identified file from the broadcast transmissions, extracting the requested UDP packets from the received file, and passing the extracted UDP packets to the requesting application operating within the receiver device. In a further embodiment the method may also include storing version identifying information in memory in the receiver device, the version identifying information indicating a version of the received identified file, monitoring the broadcast scheduling message for new versions of the identified file, and receiving in the receiver device an updated version of the identified file from the broadcast network when the broadcast scheduling message indicates that a new or updated version of the identified file is being broadcast. In a further embodiment the file capture request may be received by the receiver device in the form of commands to capture a file containing the requested UDP packets once or as a command to capture all instances of the file. In a further embodiment the generated broadcast scheduling message may further identify a time when the broadcast scheduling message will be updated, and the method may further include broadcasting the broadcast scheduling message multiple times within the broadcast scheduling period, deactivating receiver circuitry in the receiver device after the broadcast scheduling message has been received, determining when the current time equals the time the broadcast scheduling message will be updated, reactivating the receiver circuitry in the receiver device when the current time equals the time the broadcast scheduling message will be updated, and receiving an updated broadcast scheduling message. In a further embodiment, the generated files may be scheduled for broadcast based upon a relative urgency identified by a file ingestion system. In a further embodiment the files may be generated to contain UDP packets from content providers targeting users having similar demographics, or to contain UDP packets from content providers providing similar services, such as news services. In a further embodiment the application operating within the receiver device may receive the UDP packets without being exposed to the delivery method used to deliver the UDP packets to the receiver device. In a further embodiment the broadcast communication network UDP packets for transport from a content provider may include receiving in the server UDP packets from a plurality of content providers, and generating files containing the received UDP packets in the server may include generating a single file containing UDP packets received from at least two different content providers. In a further embodiment extracting the requested UDP packets from the received file may include extracting UDP packets from a plurality of content providers from the received file, and passing the extracted UDP packets to the requesting application may include passing selected extracted UDP packets to a plurality of requesting applications.

Further embodiments may include a broadcast communication system including a broadcaster network and receiver devices which includes means for performing functions of the embodiment methods described above.

Further embodiments may include a server having memory and a processor configured to perform the operations of the embodiment methods described above that are accomplished within a broadcaster. Further embodiments may include a server having means for performing functions of the embodiment methods described above that are accomplished within a broadcaster. Further embodiments may include a non-transitory computer readable storage medium on which is stored server-executable software instructions configured to cause a server within a broadcaster network to perform the operations of the embodiment methods described above that are accomplished within a broadcaster.

Further embodiments may include receiver devices including broadcast receiver circuitry and a processor configured to perform the operations of the embodiment methods described above that are accomplished within a receiver device. Further embodiments may include a receiver device having means for performing functions of the embodiment methods described above that are accomplished within a receiver device. Further embodiments may include a non-transitory processor readable storage medium on which is stored processor-executable software instructions configured to cause a processor within a receiver device to perform the operations of the embodiment methods described above that are accomplished within a receiver device.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram illustrating a mobile multimedia broadcast communication system and cellular “unicast” communication system suitable for use in various embodiments.

FIG. 2 is a system block diagram of elements of a broadcast communication system illustrating information flows within a portion of the broadcast network according to the various embodiments.

FIG. 3 is a system block diagram of elements of a broadcast communication system illustrating functional blocks involved in delivering files and datagram packets via the broadcast network according the various embodiments.

FIG. 4 is an overview system block diagram illustrating example functional components of the various embodiments.

FIG. 5 is a diagram illustrating a file assembled by a file constructor in accordance with various embodiments.

FIG. 6 is a diagram illustrating a file delivery pipeline including multiple files and associated BSMs in accordance with various embodiments.

FIG. 7 is a communication and software protocol stack architecture diagram illustrating how the various hardware and software protocol modules interact according to the various embodiments.

FIG. 8 illustrates functional modules that may be implemented within a receiver device suitable for implementing the various embodiments.

FIG. 9 is a process flow diagram of an embodiment method for generating and transmitting files containing data packets.

FIG. 10 is a process flow diagram of an embodiment method for requesting and receiving datagram packets over a file delivery framework.

FIG. 11 is a system block diagram of a receiver device suitable for use with any of the embodiments.

FIG. 12 is a system block of a broadcast-side server suitable for use with any of the embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The terms “mobile device” and “receiver device” are used interchangeably herein to refer to any one or all of cellular telephones, smartphones, personal or mobile multi-media players, personal data assistants (PDA's), laptop computers, tablet computers, smartbooks, palm-top computers, wireless electronic mail receivers, multimedia Internet enabled cellular telephones, wireless gaming controllers, and similar personal electronic devices which may include a programmable processor and memory and forward-link-only (FLO) mobile TV broadcast receiver circuitry for receiving and processing FLO broadcast transmissions.

The word “broadcast” is used herein to mean the transmission of data (information packets) so that it can be received by a large number of receiving devices simultaneously, and includes multicast. Examples of broadcast messages are mobile television service broadcast signals, including content broadcasts (content flow) and overhead information broadcasts (overhead flow) such as metadata messages.

A number of different mobile broadcast television services and broadcast standards are available or contemplated in the future, all of which may implement and benefit from the various embodiments. Such services and standards include, e.g., Open Mobile Alliance Mobile Broadcast Services Enabler Suite (OMA BCAST), Digital Video Broadcast IP Datacasting (DVB-IPDC), Digital Video Broadcasting-Handheld (DVB-H), Digital Video Broadcasting-Satellite services to Handhelds (DVB-SH), Digital Video Broadcasting-Handheld 2 (DVB-H2), Advanced Television Systems Committee-Mobile/Handheld (ATSC-M/H), and China Multimedia Mobile Broadcasting (CMMB). Each of these broadcast formats involves a broadcast communication channel. For ease of reference, the various embodiments may be described with reference to a FLO broadcast systems. However, references to FLO terminology and technical details are for illustrative purposes only and are not intended to limit the scope of the claims to FLO technology or any a particular FLO communication system unless specifically recited in the claim language.

Generally, applications running on receiver devices (device applications) may receive data updates through a “point-to-point” communication system. Point-to-point communication systems typically use a request/response method of communication, whereby device applications connect to a well known server, request data, download the requested data, and use the downloaded data to present users with updated information and/or services. This request/response method of communication is inefficient and consumes a significant amount of the available bandwidth. This is especially true when a large number of devices request the same information at the same time—a common scenario for devices running popular and/or high-demand applications requiring regular updates, such as news, traffic, and weather applications.

An alternative to the point-to-point system described above is a broadcast-based communication system. In broadcast systems (e.g. FLO TV or other broadcast systems), data is transmitted so that it may be received by a large number of receiving devices simultaneously. Unlike point-to-point systems, receiver devices in broadcast communication networks do not connect to a server and/or expressly request data. Rather, in broadcast systems, data is periodically transmitted over the network for reception by all receivers, and individual receiver devices either continuously listen for the data or periodically “wake up” at scheduled times to selectively receive the data being broadcast. Thus, broadcast networks generally only transmit data and do not have a direct return communication link from the receiver device to the broadcast server. These and other characteristics provide broadcast networks with some advantages as well as some disadvantages compared to point-to-point systems.

One of the numerous advantages of using a broadcast system is that device applications receiving data updates over broadcast do not incur as much cost (in terms of time, efficiency, bandwidth, battery consumption, etc.) as they would in a point-to-point system, because the receiver devices do not have to expressly request information. Another advantage is that broadcast systems are more efficient at delivering data to popular, high-use and high-demand applications. This is partially because it is cheaper and more efficient to broadcast high-demand data to a large number of recipients at the same time, rather than to each device individually. By broadcasting the same content widely, broadcast systems can deliver content to receiver devices much faster using much less bandwidth that is possible if the content is transmitted to one receiver device at a time, as in unicast systems. For these and other reasons, using a broadcast system to deliver data useful to multiple receivers can yield improvements in system efficiency, such as measured in terms of cost-per-bit, and can improve the receiver battery life of receiver devices.

Broadcast systems also have a number of limitations compared to point-to-point systems. As mentioned above, receiver devices must either continuously listen for data or periodically “wake up” to receive data. Continuously listening for data is inefficient, consuming a lot of battery power that may lead to short battery life and impact the user experience. On the other hand, by periodically “waking up” to receive information the receiver device risks data loss, as the device may not be “awake” when the desired information is broadcast. Further, since broadcast systems only transmit and do not have a direct return link, broadcasters have no way of knowing whether the receiver devices have correctly received the data. Thus, data loss and data integrity are common problems when transmitting data over a broadcast network.

To alleviate problems associated with data integrity, numerous protocols exist for grouping information into self contained “packets” and transmitting the individual packets over the broadcast network. Such transmission packets may contain error correction codes that allow receiver devices to detect and correct erroneous and/or corrupt data within received packets. These protocols also help improve system performance by grouping and transmitting data in chunks, so that the loss of one packet will not affect a receiving device's ability receive and decode future packets. A receiver can just ignore the contents of an entire packet and correctly decode the next received coherent packet.

One such protocol for broadcasting/transmitting information is the User Datagram Protocol or Universal Datagram Protocol (UDP). With UDP, applications can send messages (i.e., datagrams), to other hosts on an Internet Protocol (IP) network (or other networks) without requiring prior communication links to set up special transmission channels or data paths. However, UDP uses a simple transmission model without any implicit hand-shaking for guaranteeing packet reliability or ordering. Thus, UDP provides an “unreliable service,” as the transmitted datagrams may arrive out of order, appear duplicated, or go missing without notice. That is, while each individual UDP packet may contain error correction codes for correction of data contained within each individual packet, UDP packets may not include information regarding other UDP packets. Accordingly, most systems using UDP to transmit or receive data must assume that error checking and correction is either not necessary or performed locally by the receiving device. Also, UDP packets typically contain a relatively small amount of information. This means that each UDP packet is transmitted within only a small amount of time. Such short transmission times can be easily missed by mobile receiver devices due to the device's mobile nature (e.g., when a mobile phone travels into a tunnel) and battery conservation features (e.g., the device waking up a few microseconds late).

Other protocols for broadcasting/transmitting information in the form of datagrams include AppleTalk and NetBIOS, which share many of the same characteristics of UDP packets described above. For ease of reference, the various embodiments and examples are described with reference to UDP datagrams. However, references to the UDP terminology and technical details are for illustrative purposes only and are not intended to limit the scope of the claims to a particular type of datagram, unless specifically recited in the claims.

The various embodiments overcome the above mentioned limitations by utilizing a broadcast based File Delivery Framework (FDF) service to deliver datagram (e.g., UDP) packets to applications running on receiver devices. Specifically, the various embodiments provide mechanisms and systems for efficiently delivering datagram packets to receiver devices by embedding the datagram packets within files, and delivering the files using the FDF service of a broadcast system. The various embodiments utilize the built in broadcast scheduling, redundancy, error correction and reliability mechanisms provided by the FDF service to deliver datagram packets in a timely, reliable, coherent and effective manner.

The various embodiments provide mechanisms and systems for efficiently delivering datagram packets by embedding the datagram packets within files, and delivering the files over a broadcast system to receiver devices using the FDF service. Files for broadcast and reception in accordance with the various embodiments may be logically identified as belonging to a directory in a file system. In order to make use of this file system abstraction for the broadcast of files containing datagram packets, the broadcast system broadcasts information to receiver devices regarding the files that will be broadcast, and when the files are scheduled for broadcast. This broadcast schedule notification may be accomplished by broadcasting Broadcast Schedule Messages (BSMs) which include information to inform receiver devices of file broadcast schedules, along with the identity of the datagram packets that will be included in those files. Receiver devices receiving BSMs can use them to determine whether and when to receive file transmissions from the FDF service in order to download datagram packets relevant to applications running on the receiver devices.

Each BSM may include file content and broadcast schedule information such as: the association of files being broadcast with various services or applications (e.g., a service ID or a file name on an application specific directory); identification of whether a file being broadcast is a new, updated or repeated file (e.g., a file ID or version number); the broadcast transport stream where the file can be received (e.g., a flow ID, an IP flow identified by an IP address and UDP port number); the time at which the file will be broadcast (e.g., a delivery window); when the delivery schedule information (e.g., the BSM) may be updated with new information; whether the file contains datagram (e.g., UDP) packets; the types of datagram packets contained, if any; and information (e.g., a look-up table) associating applications with individual datagram packets and/or datagram packet groups and blobs that will be included in each broadcast file.

The BSM may be carried as part of an overhead transport stream (e.g., a flow ID, an IP address and UDP port number) that provides the delivery schedule information for files broadcast on a given frequency (e.g., channel 55), on a portion of the transmit spectrum in that frequency (e.g., a FLO local vs. wide multiplex), and/or for a transport technology (e.g., FLO or ATSC). The availability of these overhead flows, the channel, flow or frequency used for such transmissions, the portion of the signal or super-frames where the BSMs are broadcast, and the transport technology used for transmitting BSMs may be discovered via a bootstrap overhead flow (e.g., IAF in FLO).

A receiver device configured according to the various embodiments may make use of the information within BSM messages to select particular files for reception from among the different file broadcasts advertised in BSMs. Receiver devices may select files for reception based on the service or application to which the file or included datagram packets are associated. Thus, receiver devices may select files for reception based upon an identifier or applicability information included in the BSM without considering the files contents. Alternatively or additionally, receiver devices may select files for reception based upon datagram identifiers or application applicability information included in the BSMs regarding the datagram packets contained within the files. A receiver device may also make use of the BSM message to select files for reception based on whether the file is new or an update to a previously received file. The BSM may also support aliasing of application/service IDs and transporting bundles of files.

The various embodiments may include a file ingestion system (FIS) within or in communication with the broadcast network which may provide an interface that content providers can use to notify the broadcast system of new files (e.g. data files, files containing datagram packets) to broadcast. Content providers may use the file ingestion system to specify the broadcast transport requirements for files, such as the timeliness requirements (e.g., latency tolerance) and robustness requirements (e.g., level of FEC or number of retransmissions). The file ingestion system may use the transport requirements specified by content providers at the time of new file ingestion, and attempt to pack a new file into the broadcast transmission stream along with already accepted files scheduled for transmissions. File ingestion may be considered to have failed if this packing is not successful (i.e., the new file could not be fit within the transmission stream with files already scheduled for transmission).

Once a new file has been processed by the file ingestion system, the file ingestion system may generate a BSM that may advertise only a fraction of the successfully scheduled files over a broadcast schedule period, allowing receiver devices to plan reception of file broadcasts over the advertise broadcast schedule period, while allowing new file ingestions to be accommodated with modifications to the schedule information for files already accepted for transmission but whose delivery schedules have not yet been advertised via a BSM. Based on the existing schedule information, the broadcast system may control updates to the BSM and the transmission of files per advertised BSMs.

At any given time, the BSM may advertise only a portion of the broadcast schedule information. There is an inherent a trade-off between content freshness, which is maximized by limiting the amount of broadcast schedule addressed in each BSM, and power consumption (which reduces battery life) by receivers, which is minimized by maximizing the amount of broadcast schedule addressed in each BSM. Allowing BSMs to change frequently, enables broadcasters to broadcast files with shorter notice and to accommodate changes in file delivery priorities and schedules. However, receiver devices must power up to receive the BSM transmissions more often, thus consuming more battery power, when the BSM may change frequently. Thus, broadcasters may compromise in the generation of BSMs between frequently updating BSMs to enable to file broadcast schedule flexibility, and limiting the time between changes to the BSM in order to enhance the user experience.

The file ingestion system for a file broadcast system may also support ingestion of attributes associated with files, as well as formatting of the file attributes so they may be carried via an overhead message (e.g., a BSM). Such file attributes may allow receiver devices to select files for reception and download, such as by using filtering criteria to select files based on their file attributes.

The file ingestion system may also allow ingestion of multiple files at a time. Accepting multiple files together may enable files to be bundled together for transmission as a single file (or a few large files) for forward error correction efficiency. Alternatively, multiple files may be successfully scheduled for transmission if they are not bundled.

A broadcast network providing file transport services (e.g., an FDF service) may be resource bound. Therefore, it is desirable that the manner in which resources are dedicated to file transport be efficient and address different requirements associated with the different deployed file delivery applications. This is may be accomplished by organizing resources into file delivery “pipes,” which is a construct to capture the resource allocation for file transport and the multiplexing of different files on a given pipe. Different strategies may be used for defining multiple file delivery pipes on a network and scheduling files across such different pipes. Utilizing such a file delivery pipe construct, a file ingestion system may be made aware of file delivery pipes defined in the broadcast system. So informed, the file ingestion system may schedule files across such transmission resources in a manner that addresses application-specific delivery requirements specified for each of the files. Classes of applications may be mapped to specific pipes, e.g., small files with low latency requirements may be broadcast on dedicated pipes. The file ingestion system may also split transmission of large files into disjoint broadcast windows to allow short file transmissions. In an embodiment, the file ingestion system may schedule multiple concurrent file transmissions on the same pipe via different flows.

In the various embodiments, a broadcast-side application may create datagram (e.g., UDP) packets containing data for delivery to a corresponding application on receiver devices. The datagram packets may be bundled together into one or more files which are transmitted by the broadcast system over a file transport network (e.g., a FDF service). That is, in the various embodiments, a broadcast system may transport (i.e., broadcast in the form suitable for reception by suitably configured receiver devices) files containing datagram packets to particular applications or services that may be implemented on receiver devices.

In the various embodiments, the broadcast-side application or service submitting datagram packets for transport may submit a large number of datagram packets to a file ingestion system for assembly into one or more files for transport. Datagram packets from one or more applications may be multiplexed into one or more files. The corresponding application or service on the receiver device may only be compatible with, or interested in, a sub-set of the datagram packets contained in any given file among the files being broadcast. In this case, the broadcast-side application or service may supply application or service applicability metadata regarding the datagram packets and/or the assembled files to the file delivery service of a broadcast system, enabling the system to construct BSM or similar overhead file (e.g., a catalog file) that includes this identifying metadata. The BSM overhead file may list all the files that will be broadcast within a broadcast period, along with identification or applicability information for the datagram packets within each file. Such datagram packet identifying metadata may include application-specific attributes, such as the name or identifier of applications or services which can or should receive the datagram packets.

On the receiver device, the BSM overhead file may be received and the corresponding application operating on the device may use the information in this overhead file to select files and datagram packets for reception. The applications operating on the device may make this selection based on application-specific logic and available attributes.

An application operating on the receiver device may also request reception of selected files described in the BSM from the file delivery service in the broadcast system by indicating to a file delivery service module application or service file names, an identifier for a desired file, datagram packet types or application types, or specific datagram packets or datagram packet groups/blobs. The file delivery service module on the receiver device may determine from the BSM when, and on which, channel/flow/broadcast resource the indicated files containing the desired datagram packets are to be broadcast. This information allows the receiver device processor to “wake-up” the receiver circuitry only if the broadcast is likely to contain datagram packets requested by or compatible with device applications. The information in the BSM also enables receiver device processors to pinpoint the exact time frame within which the receiver needs to be on and listening for data, thereby conserving significant battery, processing, and networking resources.

An application or service on the sender side using the file delivery service (e.g., an FDF service) of a broadcast system may provide the application-specific attributes associated with the files and/or datagram packets at the time when the files are submitted to the file ingestion system for transport. Such application-specific attributes may be transported to receiver devices via the BSM. The device application may request a datagram packet capture from the receiver file delivery service module by indicating a regular expression within the applications-specific parameters which characterizes the file and/or datagram packets of interest so that such parameters may be used as file selection filtering criteria. The receiver device file delivery service module may use such filtering criteria to identify from the BSM the day/time, flow ID, etc. to receive only the desired files, or files containing the desired datagram packets.

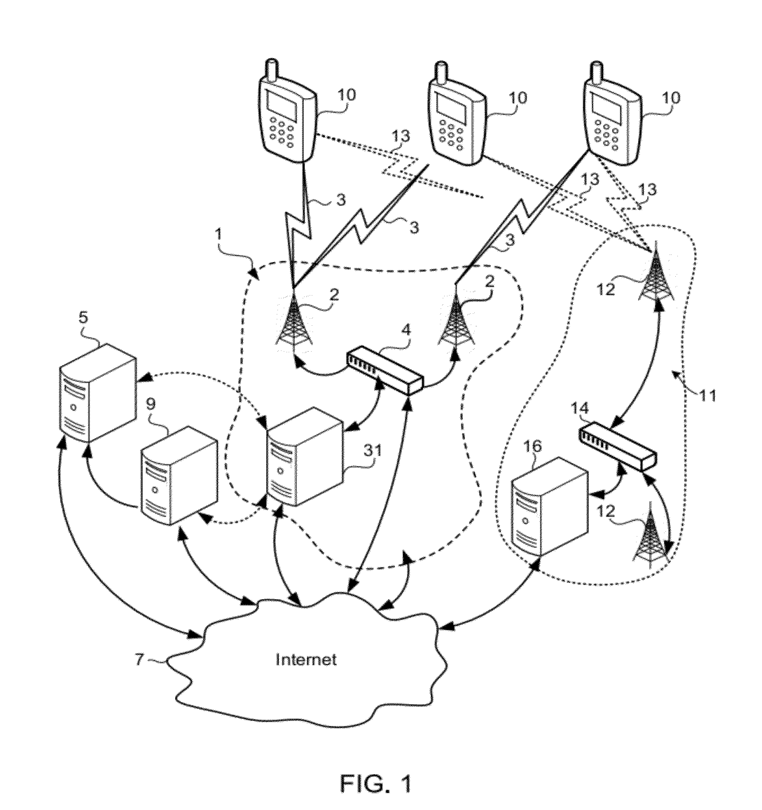

The various embodiments may be implemented within a variety of mobile multi-media broadcast systems, an example of which is illustrated in FIG. 1. A mobile multimedia broadcast network 1, such as a FLO broadcast network or other broadcast network, typically includes a plurality of broadcast transmitters 2 controlled by a mobile broadcast network control center which is referred to herein as a broadcast operation center 4 (or “BOC” in the figures). The broadcast network 1 broadcasts content from the broadcast transmitters 2 as mobile broadcast transmissions 3 for reception by receiver devices 10, such as mobile television receivers, smartphones, cellular phones, personal digital assistants (PDA), interactive game devices, notebooks, smartbooks, netbooks, data processing apparatus, or other such electronic devices. Within the mobile broadcast network control center 4 (also called the broadcast operation center or “BOC”) will typically be one or more servers and systems for managing real time content broadcasts, generation of electronic service guides and catalog messages regarding the content broadcasts, and generation of metadata messages for broadcast via the overhead flow of the multimedia broadcast network 1.

In addition to the normal content delivery system, the mobile broadcast network 1 may also include a file ingestion system (FIS) server 31 for receiving, storing, scheduling and formatting files for broadcast via the mobile broadcast network 1. The file ingestion system server 31 may receive files for broadcast from a file content provider 9, either via a direct network connection or an indirect network connection, such as the Internet 7. The file ingestion system server 31 may also receive files for broadcast from a file constructor 5, either via a direct network connection or an indirectly (e.g. via the Internet 7). The content provider 9 may also submit content in the form of datagram (e.g., UDP) packets to the file constructor 5. In this case, the file constructor 5 may package the datagram packets received from the content provider 9 into files, and submit the packaged files to the file ingestion system server 31.

In addition to the mobile multimedia broadcast network 1, receiver devices 10 will typically also be configured to communicate via a unicast network 11, such as a cellular telephone network. A typical cellular telephone network includes a plurality of cellular base stations 12 coupled to a network operations center 14, which operates to connect voice and data calls between receiver devices 10 and other network destinations, such as via telephone land lines (e.g., a POTS network, not shown) and the Internet 7. Communications between receiver devices 10 and the unicast network 11 are accomplished via two-way wireless communication links 13, such as G-3, CDMA, TDMA, and other cellular telephone communication technologies. To facilitate Internet data communications, the unicast network 11 alone will typically include one or more servers 16 coupled to or within the network operations center 14 that provide a connection to the Internet 7. In a further embodiment, the unicast network 11 may be a wireless wide area network such as WiFi, WiMAX, etc. Mobile receiver devices 10 may communicate with the broadcast network 1 via the unicast network 11, such as via an IP data call to a broadcast network server by way of the Internet 7, for purposes of subscribing to broadcast services and reporting user viewing patterns.

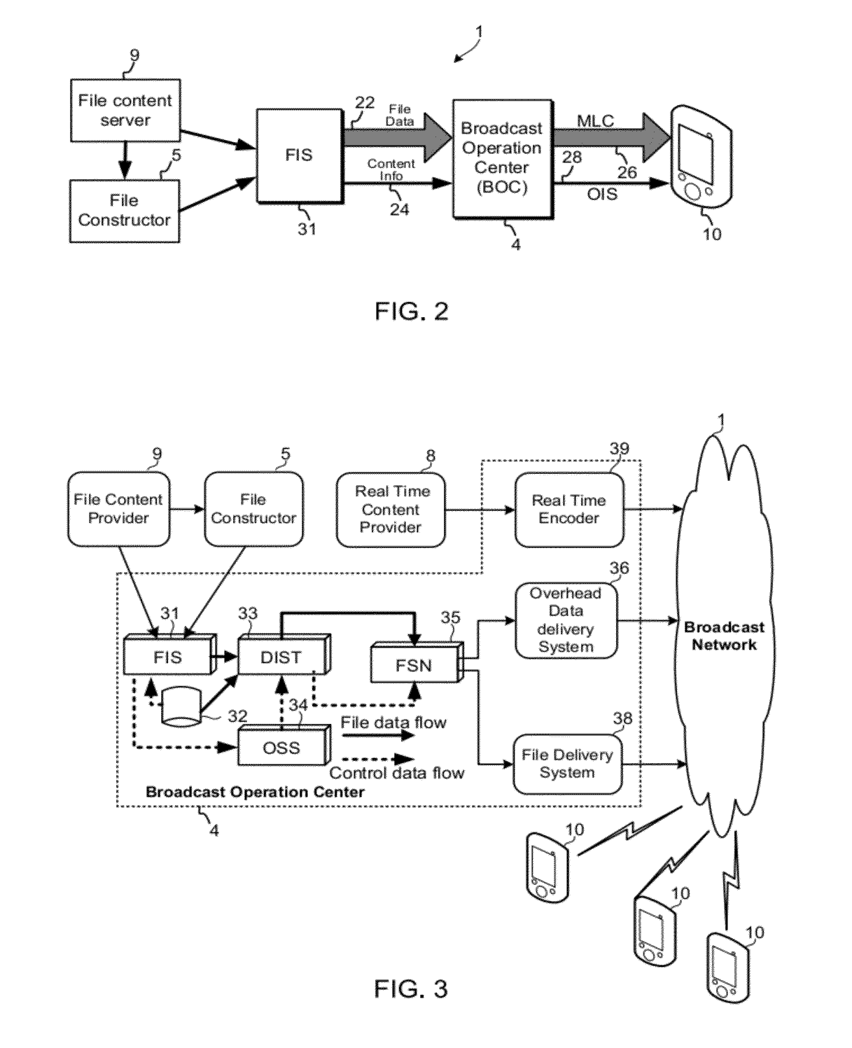

FIG. 2 illustrates information flows within a portion of a broadcast network 1 (e.g., a FLO broadcast network) according to an embodiment. File content providers 9 may provide files for transmission via the broadcast file delivery service to the file ingestion system server 31. Content providers 9 may also provide datagram (e.g., UDP, AppleTalk, NetBIOS, etc.) packets to a file constructor 5 for assembly into one or more files. The file constructor 5 may submit the constructed files (containing the datagram packets) for transmission via the broadcast file delivery service to the file ingestion system server 31. The file ingestion system server 31 may schedule and store the files for broadcast, as described more fully below. At the time for broadcast, the file ingestion system server 31 may provide the file data 22 and content info 24 to the broadcast operation center 4 (BOC), where the broadcast signal is generated as a multiplex of information that includes content flow 26, which in some systems may be referred to as media logical channels (MLC), and the overhead flow 28. Thus, files carrying datagram packets for transmission via the file delivery service may be transmitted as part of the content flow 26 while the BSM is transmitted as part of the overhead flow 28. Receiver devices 10 receive the multiplex signal and are able to separately receive the overhead flow 28 including the BSM and other overhead information streams (e.g., a control channel), and use the information in the BSM to selectively receive particular files from the content flow 26.

In a typical multimedia mobile broadcast system, information may be transmitted in wireless signals organized into a plurality of superframes. Each superframe comprises signals within a frequency band and within set time boundaries that encode a plurality of data packets that communicate the broadcast content along with overhead information used by receiver devices 10 to receive selected content. For example, in the FLO broadcast system, broadcast transmissions are organized into one-second superframes spanning a frequency band (for example 716 MHz to 722 MHz). FLO broadcast signals may be sent on other frequency bands and multiple signals may be sent simultaneously by using multiple distinct frequency bands. Each superframe includes a portion dedicated to the overhead flow and a portion that carries multiple channels associated with content flows. Information within the overhead flow and other overhead streams (e.g., a control channel) informs receiver devices of where within the superframe that particular content flow can be obtained, as well as how many packets are associated with the streams of that content flow.

FIG. 3 illustrates system functional components on the broadcaster side of a broadcast communication system suitable for implementing the various embodiments for delivering files via a file delivery service. Real time content provider servers 8 send real time content (e.g., audio, video, text, etc.) to a real-time encoder 39 within the Broadcast Operation Center 4. The file content providers 9 may provide files for delivery via the file delivery service to a file ingestion system server 31. The file content providers 9 may also provide datagram packets for delivery to a file constructor 5, which assembles the datagram packets into files and submits the assembled files to a file ingestion system server 31. The file ingestion system server 31 may store the received files in a local database 32 and schedule received files for broadcast. Information regarding scheduled broadcast time as well as file and/or datagram packet attribute data may be provided to an overhead service server (OSS) 34 which is a component that manages and advertises overhead version changes in the BSM. The ingestion and scheduling of transmission of files by the file ingestion system server 31 may be dynamic such that frequent changes to the scheduled broadcast times may be communicated to the overhead service server 34. The overhead service server may provide an updated BSM to a distribution server 33, which is a component that transmits files and overhead messages at a configured rate. The distribution server 33 may then provide the BSM for transmission to a FLO service node (FSN) 35 which directs the BSM to an overhead data delivery system 36 for transmission via the broadcast network 1. Near the scheduled transmission time, the file ingestion system server 31 along with the local database 32 may provide files for transmission to the distribution server 33. The distribution server 33 may provide the files to the FLO service node 35, along with control data specifying when each file is to be broadcast. The FLO service node 35 may then deliver files for transmission to the file delivery system 38 which transmits the files via the broadcast network 1. Receiver devices 10 may then receive the files from the broadcast network 1 via wireless data transmissions.

While FIG. 3 illustrates example components of the file delivery system as separate units or servers, one of skill in the art would appreciate that some or all of the different functional processes may be implemented within a single server or fewer servers than illustrated in FIG. 3. For example, the overhead service server 34, distribution server 33 and flow service node 35 may be implemented within a single server device with the FIS 31.

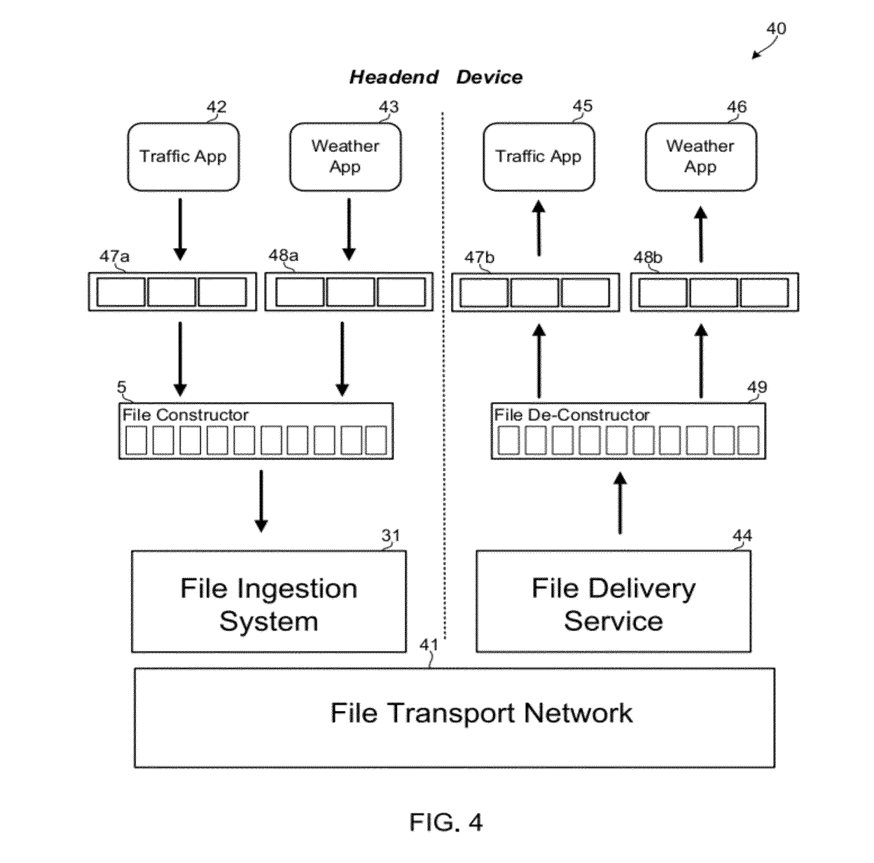

As an illustration of various embodiments, FIG. 4 illustrates top-level components involved in a broadcast File Delivery Framework (FDF) 40. While various embodiments are described herein with reference to an FDF, this term encompasses any data file delivery channel or protocol available over a broadcast network, and is not intended to require a particular type of file delivery technology or protocol. The FDF 40 may provide support for different file delivery applications concurrently. The delivery of files in the form of logical concepts involves embodiment methods used for the manipulation and management of files and/or datagram packets as they are received from content providers, transmitted via the broadcast system, and received by receiver devices. At a high-level, the broadcast file delivery system 40 comprises a headend, which is the broadcast side of the communication system, and a receiver device, which selectively receives and stores transmitted files and datagram packets. Applications providing application data for transmission, referred to herein as “headend apps” 42, 43, define files and/or datagram packets 47a, 48a, for delivery. If datagram packets are provided by the headend apps 42, 43, as illustrated in FIG. 4, a file constructor 5 may assemble and package the datagram packets, such as UDP packets, into one or more files to be ingested via the file ingestion system 31 and delivered to the receiver devices via the file transport network 41. On the receiver device side, device applications 45, 46 request datagram packets from a file delivery service module 44, and periodically listen to a designated datagram port for the requested datagram packets. The file delivery service module 44 manages the reception of files via the file transport network 41 and manages particular files to receive and store. On the receiver device, the file delivery service module 44 may deliver received files to a file de-constructor 49 for parsing. The file de-constructor 49 may parse the received files to extract the datagram packets 47b, 48b requested by device applications. The file de-constructor 49 may send the extracted datagram packets 47b, 48b to the datagram ports listened to by the device applications 45, 46.

In assembling files to be transmitted, the file constructor 5 may create the files using a file system analogy, where a file path name in an application-specific directory structure uniquely identifies a file for a set of applications. The file constructor 5 may also insert identifiers into the file to be transmitted identifying the source and location of individual datagram packets within the file. As described above, within a server in the headend of the broadcast system the file ingestion system (FIS) 31 may be provided to receive files for transport, schedule the files for delivery opportunities in the broadcast schedule, and store successfully scheduled files in memory for later transport over the file transport network 41 of the broadcast network. The file ingestion system 31 may specify additional attributes regarding the files, such as a filename, parameters descriptive of the file (e.g., genre, file type, etc.), parameters descriptive of the file contents (e.g. source and location of individual datagram packets, identity, application or file types of the datagram packets included in the file, etc.), and other information associated the content of files for transport. The file ingestion system 31 may also specify parameters describing each file's broadcast delivery requirements. In various embodiments, the file ingestion system 31 may assign a unique identifier to files (e.g., a fileID) which can be used for versioning purposes and for bundling submitted files into combined packages for efficient application of forward error correction (FEC) codes. For example, file identifiers can be use to uniquely identify each file, identify the version of the identified file, and provide a sequence order for the file or packets. The file ingestion system may also apply forward error correction codes to ingested files to improve their broadcast transport reliability.

In an embodiment, the file ingestion system 31 may schedule broadcast delivery opportunities for newly received files for transport. As part of this process, the file ingestion system 31 may determine a transmission schedule based on various parameters. For instance, in an embodiment, the file ingestion system may create a transmission schedule as a function of the file sizes and available resources. In another embodiment, transmission schedules may also take into consideration a priority assigned to the files, or the datagram packets contained within the files, by the content providers. The scheduling of the file broadcast times may be accomplished algorithmically to determine start times for transmission such that the broadcast delivery requirements for the newly received files and the previously ingested files are met. The file ingestion system 31 may store successfully scheduled files for later transport over the file transport network 41. The file ingestion system 31 may, at the appropriate time, dispatch scheduled files to the broadcast network according to the file schedule information previously determined by the file ingestion system 31.

In scheduling files for transmission, the file ingestion system 31 may be aware of the transmission resources, such as file delivery pipes defined in the file transport network 41 for the broadcast of files. Using the information regarding the availability of file delivery pipes, the file ingestion system 31 may schedule files across the various transmission resources so as to address the application-specific delivery requirements defined by the file content providers. In some embodiments, the file ingestion system 31 may be configured to use specific pipes for certain classes of applications. For instance, small files with low latency requirements may be broadcast on dedicated transmission pipes. Alternatively, the file ingestion system 31 may split transmissions of large files into disjoint broadcast windows to allow short file transmissions with reduced delay. The file ingestion system 31 may also schedule multiple concurrent transmissions of the same type via different transmission pipes.

On the receiver device, such as a FLO receiver device, a file delivery service module 44 may be implemented within software to provide file capture services for the device applications 45, 46. The file delivery service module 44 may receive requests for datagram packets (e.g., UDP packets identified by type, identifier, etc.) from the device applications 45, 46, and use delivery information and scheduling in the BSM to capture the files carrying the requested datagram packets (or requested types of data packets) and store them in memory.

As part of the file delivery framework 40, a series of BSMs may be broadcast in an overhead message flow that is available in the broadcast transport network. As discussed above, the BSMs may provide information that enables receiver devices to associate files being broadcast, and the datagram packets contained within the files, with a particular service or application (e.g., a service ID or filename on an application-specific directory). The BSMs may also include file ID or version information on files being broadcast, information on the transport stream where the files can be received (e.g., a flow ID, an IP flow identified by an IP address, and a UDP port number), information on when the file will be broadcast (e.g., a delivery window), information on when the delivery schedule will be updated with new information (i.e., when a new version of the BSM will be transmitted), information on whether the file contains datagram packets, datagram packet IDs, and/or information (e.g., a look-up table) associating applications with either individual datagram packets or datagram packet groups and blobs.

Thus, in various embodiments, the FDF 40 enables application data providers 42, 43 to provide data in the form of datagram packets, such as UDP packets, for transport via the file transport network 41 to receiver devices that selectively receive the files containing those datagram packets requested by device applications 45, 46. The delivery of datagram packets via the file transport network 41 provides many benefits over existing systems, such as improved reliability, battery consumption, and efficiency. The improved reliability is due, in part, to the error correction and transmission properties of the FDF. Battery consumption is improved because the receiver devices can determine, from the BSM, when to “wake up” from a low power state to listen for the desired transmissions. Thus, the receiver devices do not need to wake up periodically, as they know exactly when the desired information is to be broadcast. Further, the receiver devices only “wake up” if they are interested in a particular set of datagram packets being broadcast. Otherwise the receiver devices can remain in a low-power consumption state, thereby significantly improving battery consumption.

Another advantage of delivering datagram packets via the file transport network 41 is that the communication system's overall efficiency may be greatly improved. This is in part due to the inherent efficiencies of the FDF described above. For example, by embedding the datagram packets within files, the forward error correction encoding can be implemented within the FDF for an entire set of datagram packets, as opposed to forward error encoding each datagram packet individually.

In various embodiments, efficiency may further be improved by selectively bundling datagram packets from different source-applications when there is a high probability that a receiver device will be interested in more than one of the sources, i.e., more than one of the datagram packets included within a broadcast file. For example, in one embodiment, UDP datagram packets from similar source applications (e.g., NY Times, Washington Post, etc.) may be bundled together into one or more files. In another embodiment, UDP datagram packets from source-applications targeted to a particular user demographic (e.g. 21-30 year-old males) may be bundled together into one or more files. The logical grouping of UDP datagram packets within files based on anticipated device-application usage, demographics, and/or usage probabilities allows for the creation of files that are likely to contain datagram packets requested by more than one of a device's applications. This results in receiver devices having to “wake-up” less often because information likely to be requested by multiple applications running on a single device are more likely to be contained in a single broadcast file. Since receiver devices must generally receive the entire broadcast file before they can extract the datagram packets requested by applications, the receiver devices incur little or no additional cost when receiving datagram packets for multiple device-applications in the same file. Also, the logical grouping of datagram packets within files based on related device-applications allows for the creation of broadcast files that are likely to contain datagram packets requested by many different receiver devices. For example, while a few users may elect to view the New York Times on their receiver device, many more users are likely to view at least one newspaper publication on their receiver devices. So, bundling newspaper related UDP datagram packets into one or more files may be more efficient in terms of bandwidth utilization than distributing such packets across many different broadcast files.

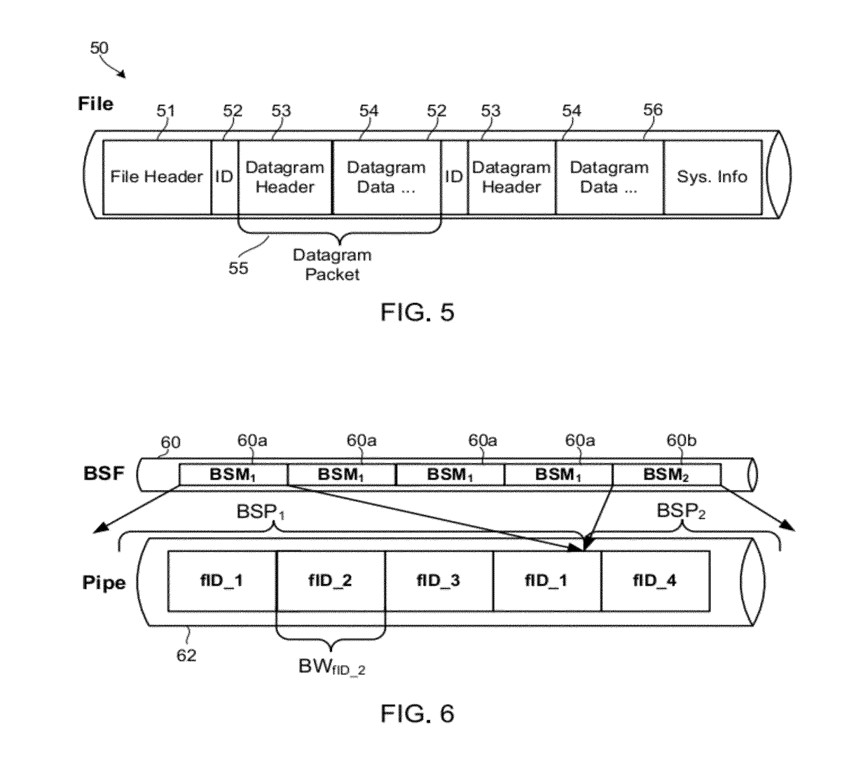

FIG. 5 illustrates a file 50 of datagram packets 55 assembled by the file constructor 5 and prepared for transport via the file transport network 41. The file 50 may contain a file header 51, IDs 52, datagram packets 55, and system information 56. The datagram packets 55 may each include a datagram header portion 53 and a datagram data portion 54, such as is standard in UDP packets. The datagram header portion 53 of the datagram packets 55 may include a source port number, a destination port number, the length of the entire datagram packet 55, and a checksum for error-checking both the datagram header portion 53 and the datagram data portion 54 of the datagram packet 55. The datagram data portion 54 may contain the content provided by the content provider for delivery to the receiver-side applications. The IDs 52 may identify the one or more headend applications that generated the datagram packets 55 and/or the one or more device applications requesting the information contained by the datagram packets 55. The IDs 52 may also include additional information about both the source applications transmitting the datagram packets 54 and destination applications that may use the datagram packets 55.

The file header 51 may include information regarding the file itself (e.g. file length, transmission format), as well as the contents of the file (e.g., sources and locations of datagram packets). The file header 51 may also include additional information that allows the efficient application of forward error correction (FEC) codes. The file header 51 may contain information, such as a lookup-table that cross-references the content sources with IDs 52 located within a file. In some embodiments, the lookup-table may be used to locate the datagram packets originating from specific content sources and/or headend applications. The lookup-table may also allow the file to deliver datagram packets generated from multiple sources to multiple applications on receiver devices. In an embodiment, information about the content sources is conveyed in the form of a character string. In various embodiments, the file header 51 may include the number and location of the datagram packets associated with a particular source. In various embodiments, the file header 51 may also include a unique identification (e.g., a fileID), which can be used for versioning purposes and/or for identifying files bundled together into combined packages for transport via the file transport network 41.

As mentioned above, files transported via the file transport network 41 may be bundled together into combined packages for more efficient transmission and application of forward error correction (FEC) codes. FIG. 6 illustrates a file delivery pipeline transporting multiple files and associated BSMs. In the example illustrated in FIG. 6, a file delivery pipe 62 is scheduled to carry a sequence of files 50, each identified with a different transport file ID, such as files fID_1 through fID_4. Such file IDs may provide implicit or explicit versioning support. For example, each submitted version of a file may be assigned a new file ID. Alternatively, the file IDs may include a first portion that is unique to the file, and a second portion that identifies the version of that file (e.g., a version number). Each BSM may be broadcast regularly, such as every superframe, and provide broadcast window and reception information for a plurality of files to be broadcast within a broadcast schedule period address by the BSM. The files transmitted in the file delivery dataflow may be of different broadcast durations, since the files may be of different sizes.

Each file 50 may be scheduled to be broadcast within a particular broadcast window (BW), such as the illustrated example of broadcast window BW_{fID}_{_{—}}₂ which corresponds to the time during which file fID_2 will be transmitted. The transport pipe data rate and the file sizes may define the broadcast window required to transmit each file over the dedicated type. Thus, the broadcast window may be proportional to the file size divided by the file pipe data rate.

Files that will be broadcast along with their broadcast window and transmission metadata may be described in BSMs 60a, 60b which may be carried by a broadcast schedule flow 60. The broadcast schedule flow (BSF) 60 may be an overhead flow separate from the content flows including the file delivery pipes 62, or may be a portion (e.g., time, frequency or symbol) of a broadcast channel known by receiver devices to carry the BSMs 60a, 60b. In order to enable receiver devices to timely activate their receiver circuitry to receive selected files, the BSM 60a, 60b carrying information regarding files is transmitted in advance of when the files are to be transmitted. In order to enable reliable reception of the BSM, the same BSM may be repeatedly broadcast on a frequent basis, such as every superframe, every second, or every few seconds. Since multiple files may be available and scheduled for over the air transmission, and the schedule may change as new files are submitted for transmission, only a fraction of the scheduled files may be described in a given BSM 60a, 60b. The information included within a given BSM 60a, 60b may thus describe a series of files that will be broadcast within a broadcast schedule period (BSP), which defines the amount of advertised file broadcast schedules included in a BSM. This is illustrated in FIG. 6 which shows how the same BSM₁ message 60a, which describes all of the files scheduled for broadcast within a given broadcast schedule period (i.e., BSP₁), is broadcast several times within the broadcast schedule flow 60, as shown by BSMs 60a. To enable flexibility in the delivery of files via the broadcast network, the broadcast schedule period may be relatively short, and BSMs 60a, 60b may be updated regularly within the broadcast schedule flow 60. Thus, as illustrated in FIG. 6, the BSM 60a, 60b included within the broadcast schedule flow 60 may be regularly updated (illustrated by BSM₂ 60b which corresponds to the files that will be broadcast within BSP₂).

It should be noted that FIG. 6 illustrates a scenario in which multiple broadcast windows exist during a broadcast schedule period for a single file, such as illustrated for file ID fID_1. Multiple broadcast windows for a single file may be used when a file is transmitted multiple times to improve the success rate for the file transmission, as may be appropriate for high-priority files. Multiple broadcast windows for single file may also be necessary when a file is so large that it must be split into disjoint pieces, to enable other files to be transmitted concurrently. When there are multiple broadcast windows for a single file, those multiple broadcast windows may appear within the same broadcast schedule period or in different broadcast schedule periods.

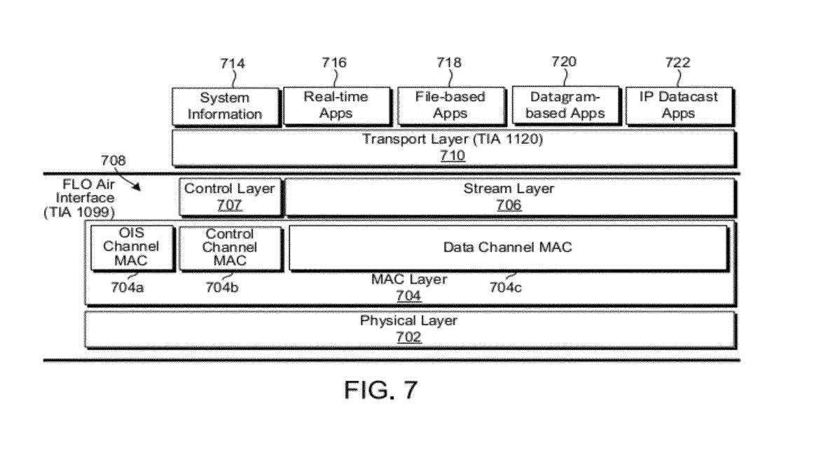

FIG. 7 is a protocol stack diagram illustrating the interactions of the various hardware and software protocol modules within a FLO mobile broadcast receiver device. A FLO receiver may include a FLO air interface 708 which includes hardware and software modules defined by the Telecommunication Industry Association specification TIA 1099. The FLO air interface includes a physical layer 702 of radio components that receive the basic signal and provide the received data to a media access control layer (MAC layer) data communication protocol sub-layer 704. The MAC layer provides addressing and channel access control mechanisms that make it possible for various components of the receiver to receive the different streams of data, including datagram packets, encoded in the broadcast signal. The MAC layer may be implemented in hardware, in software, or in a combination of hardware and software which may be referred to as a medium access controller. The MAC layer may include an OIS Channel MAC 704a, a Control Channel MAC 704b, and a Data Channel MAC 704c.

The portions of the broadcast signal carrying the content and information flows may be passed by the MAC layer 704 to a stream layer 706, which is the data interface to the transport layer 710 (which is defined by TIA 1120) in the receiver device. The FLO air interface 708 may also include a control layer 707 for controlling the various operations of the air interface. Broadcast data received in the transport layer 710 may be processed and delivered to the appropriate upper layer modules that can make use of the data, such as the system information module 714, real-time applications 716, file-based applications 718, datagram based applications 720, and IP data cast applications 722.

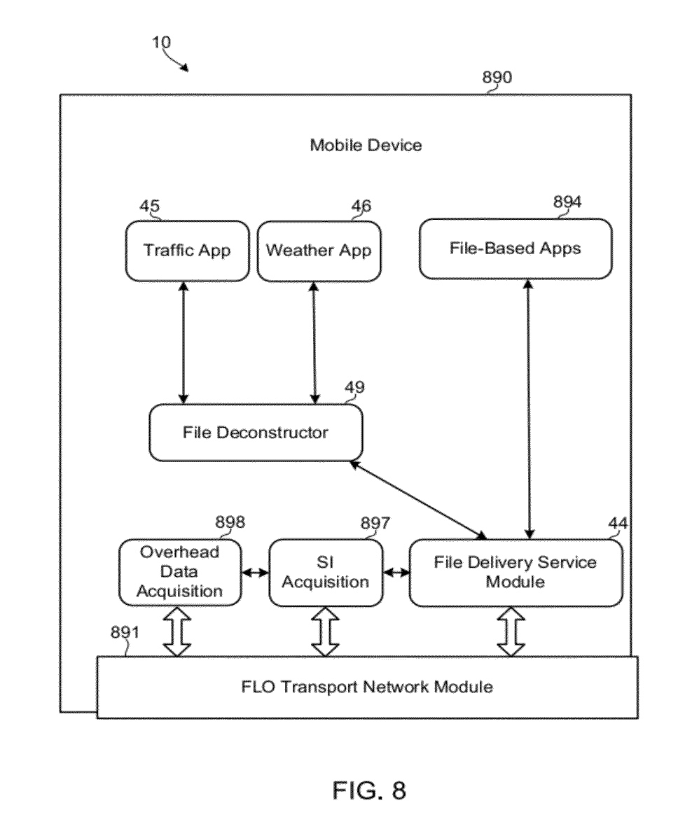

Software modules of a receiver device 10 may be organized in a software architecture 890 similar to that illustrated in FIG. 8. Broadcast transmissions may be received by a receiver device physical layer and processed by a broadcast receiver module, such as a FLO transport network module 891. Video and audio streams received by the file transport network 891 may be processed by a media receiver module (not shown). File transfer streams received on the file transport network 891 may be provided to and processed by a file delivery service module 44, which functions to receive files and datagram packets, such as UDP packets, and direct them to appropriate modules and applications within the device software architecture 890. For instance, the file delivery service module 44 may direct files containing information for file based applications 894 directly to those applications 894, and at the same time, direct files containing datagram packets to a file de-constructor 49, which extracts the datagram packets from the files and provides device applications 45, 46 with the requested datagram packets.

Overhead data streams may be passed to an overhead data acquisition module 898, which may function to process overhead data packets and direct received metadata and overhead data to appropriate modules within the device system architecture 890. A Service SI acquisition module 897 may acquire the Service SI data from the overhead data streams, and forward this information to the file delivery system module 44 and overhead data acquisition module 898. From received Service SI data, the file delivery system module 44 may determine flow IDs for file data flows carrying datagram packets. From received Service SI data, the overhead data acquisition module 898 may determine signaling flows carrying datagram packets.

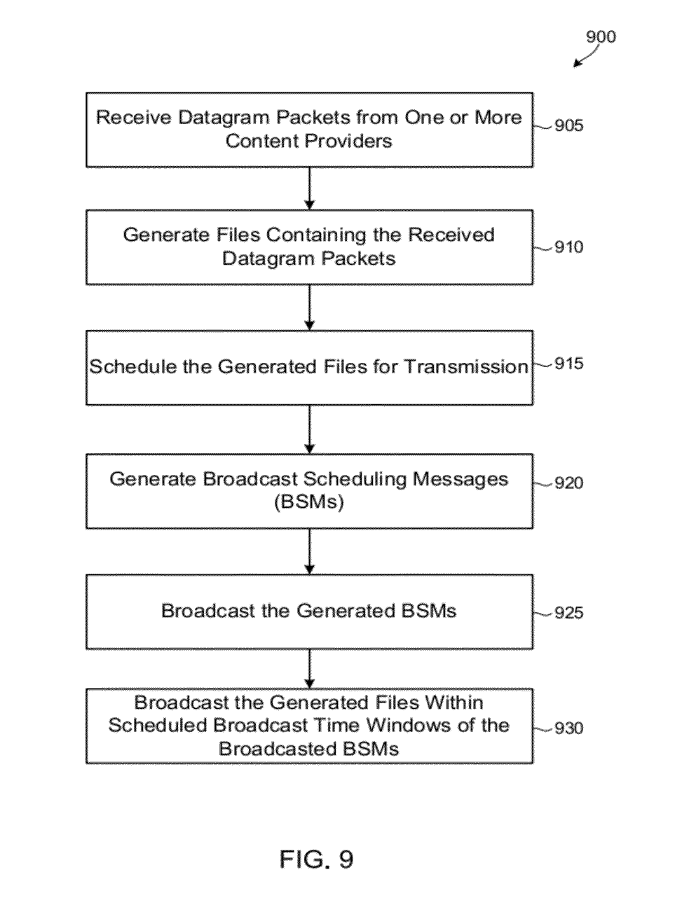

An example method 900 for sending datagram packets through the file transport framework is illustrated in FIG. 9. In method 900 at block 905, content providers package data for delivery into datagram packets, such as UDP packets, and provide the datagram packets to a file constructor. In block 910 the file constructor constructs broadcast files containing the received datagram packets. As discussed above, as part of block 910 the file constructor may insert identifiers into the file to be transmitted identifying the type, name, source and/or location of individual datagram packets within the file. The file constructor may also package datagram packets from similar source applications (e.g. NY times, Washington post) or source-applications targeted to a particular user demographic (e.g. 21-30 year-old males) into a single file such that each file is more likely to contain datagram packets requested by two or more device applications running on a single receiver device. Packaging datagram packets from more than one application into a single, larger file and/or bundle also provides additional efficiency improvements, because the error correction technology (e.g., FEC) is generally stronger for larger files.

The file constructor may send the constructed files to a file ingestion system, which schedules the generated files for transmission in block 915. In block 920 the file ingestion system may store the received files in a local database and generate BSMs that identify the scheduled files, the datagram packets contained within the scheduled files, and timing information that indicates a time window and/or time range in which the scheduled files are to be broadcast. In block 925, the broadcast system broadcasts the generaged BSMs, such as on a frequent basis (e.g., every superframe, second or few seconds). In block 930, the broadcast system broadcasts the files containing the datagram packets in the time window/range identified in the BSMs.

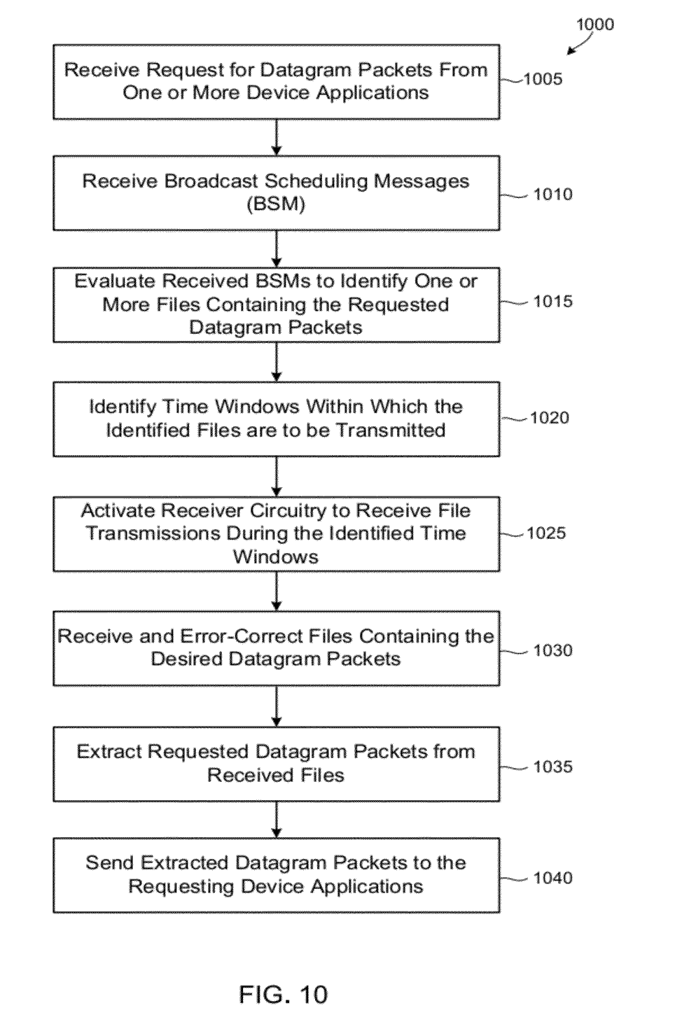

An example method 1000 for receiving datagram packets transmitted through the file transport framework is illustrated in FIG. 10. In method 1000 in block 1005, a receiver device processor receives a request from one or more device applications for datagram packets. This request may be in the form of the application registering with the a file delivery module to indicate the datagram file types, identifiers, sources, etc. that the application is interested in receiving. In block 1010, the receiver device processor, in response to the request for datagram packets, may monitor transmissions over the broadcast network to receive a new or updated BSMs. This monitoring of BSMs may be managed by a file delivery module operating within the device processor. In block 1015, the processor (e.g., a file deliver module) may evaluate the received BSMs to identify files containing requested datagram packets. If one or more files are identified as containing requested datagram packets, in block 1020, the processor uses the BSM to identify a time window and/or time range in which each of the identified files are to be broadcast by the network. In block 1025, the processor activates (i.e., turns on) the wireless receiver circuitry at a time indicated in one of the identified time windows to receive the identified file broadcasts. Received files may be stored in a local memory, such as a processing buffer, and in block 1030 the processor may execute error correction algorithms to ensure proper and complete reception of the identified file and its contents. In block 1035, the processor (e.g., in a file deconstructor module operating in the processor) may use the information contained in the header portion of the error-corrected file to extract the datagram packets requested by the device applications running on the receiver device. In block 1040, the extracted datagram packets may be sent to the device application(s) that requested the extracted datagram packets. The applications may then use the data contained within the datagram packets and perform their normal functions, such as present users with new and/or updated information and services. For example, when the datagram packets are UDP packets, the requesting application may process the received UDP packets as if they had been received via any other type of communication link.

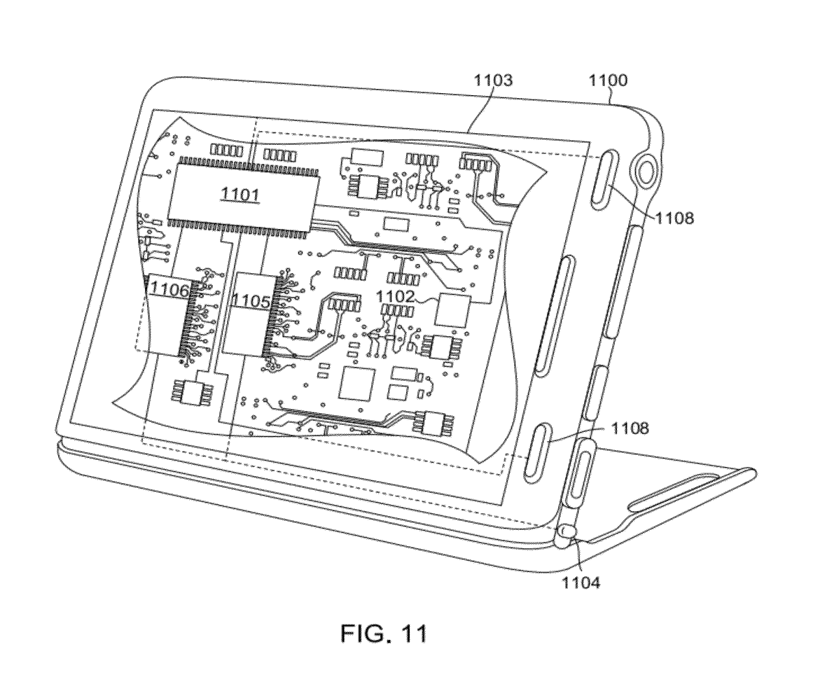

FIG. 11 is a system block diagram of a receiver device suitable for use with any of the embodiments. A typical receiver device 1100 may include a processor 1101 coupled to internal memory 1102, to a display 1103, and to a speaker 1108. Additionally, the receiver device 1100 will include an antenna 1104 for sending and receiving electromagnetic radiation that may be connected to a wireless data link and/or cellular telephone transceiver 1105 coupled to the processor 1101 and a mobile multimedia broadcast receiver 1106 coupled to the processor 1101. Receiver devices 1100 typically also include menu selection buttons 1107 or rocker switches for receiving user inputs.

The various embodiment methods for receiving and processing interactivity event signaling messages may be performed by the multimedia broadcast receiver 1106 and portions of the processor 1101 and memory 1102. Alternatively dedicated modules within or coupled to the multimedia broadcast receiver 1106 may perform the embodiment methods.

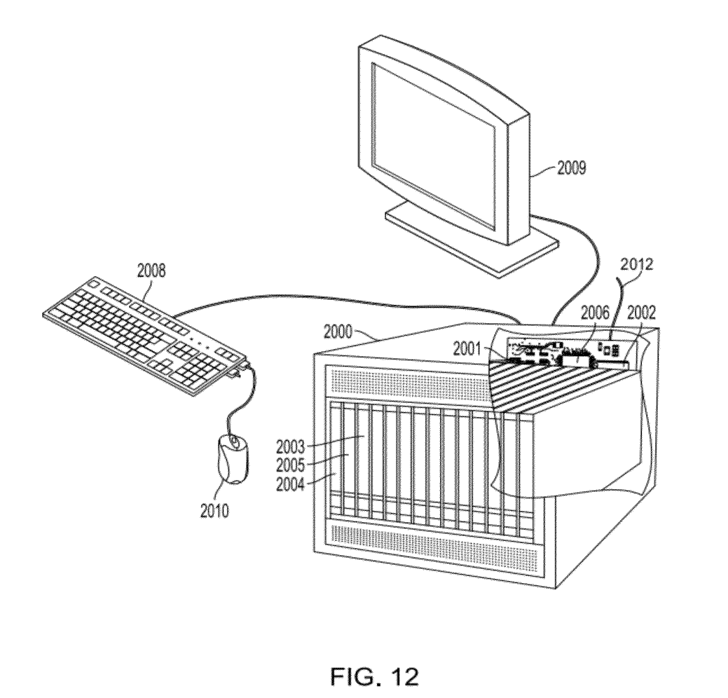

The various embodiments may be implemented on the broadcast side on any of a variety of commercially available server devices, such as the server 2000 illustrated in FIG. 12. Such a server 2000 typically includes a processor 2001 coupled to volatile memory 2002 and a large capacity nonvolatile memory, such as a disk drive 2003. The server 2000 may also include a floppy disc drive, compact disc (CD) or DVD disc drive 2004 coupled to the processor 2001. The server 2000 may also include network access ports 2006 coupled to the processor 2001 for establishing data connections with a network 2012, such as a local area network coupled to other broadcast system computers and servers. Servers 2000 may also include operator interfaces, such as a keyboard 2008, pointer device (e.g., a computer mouse 2010), and a display 2009.

The processors 1101, 2001 may be any programmable microprocessor, microcomputer or multiple processor chip or chips that can be configured by software instructions (applications) to perform a variety of functions, including the functions of the various embodiments described below. In some mobile receiver devices, multiple processors 2001 may be provided, such as one processor dedicated to wireless communication functions and one processor dedicated to running other applications. Typically, software applications may be stored in the internal memory 1102, 2002, 2003 before they are accessed and loaded into the processor 1101, 2001. The processor 1101, 2001 may include internal memory sufficient to store the application software instructions.

The foregoing method descriptions and the process flow diagrams are provided merely as illustrative examples and are not intended to require or imply that the operations of the various embodiments must be performed in the order presented. As will be appreciated by one of skill in the art the operations in the foregoing embodiments may be performed in any order. Words such as “then,” “next,” etc. are not intended to limit the order of the operations; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

When implemented in software, the functions may be stored as one or more instructions or code on a non-transitory computer-readable or processor-readable storage medium. The operations of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

When implemented in hardware, the functionality may be implemented within circuitry of a wireless signal processing circuit that may be suitable for use in a wireless receiver or mobile device. Such a wireless signal processing circuit may include circuits for accomplishing the signal measuring and calculating operations described in the various embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

Any reference to claim elements in the singular, for example, using the articles “a,” “an” or “the” is not to be construed as limiting the element to the singular.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for delivering user datagram protocol (UDP) packets to a receiver device over a broadcast communication network, comprising:
receiving, in a server of the broadcast communication network, UDP packets for transport from a content provider;
generating in the server files containing the received UDP packets, the generated files having a file name and containing information regarding the UDP packets contained in the files and communication requirements;
scheduling the generated files for transmission via a file data flow within a broadcast transmission;
generating a broadcast scheduling message indicating when files will be broadcast within a broadcast scheduling period, information regarding those files, and a scheduled broadcast time window for each file;
broadcasting the generated broadcast scheduling message via the broadcast communication network; and
broadcasting the generated files via the file data flow of the broadcast communication network in accordance with the scheduled broadcast time windows included within the broadcast scheduling message.

2. The method of claim 1, further comprising:
receiving from an application operating within the receiver device a request to capture UDP packets, the request specifying one or more reception criteria;
receiving the broadcast scheduling message in the receiver device;
identifying for reception a file containing UDP packets matching the reception criteria based on information in the received broadcast scheduling message;
identifying from the broadcast scheduling message the scheduled broadcast time window when a file matching the reception criteria will be broadcast;
activating a receiver circuitry of the receiver device at the identified scheduled broadcast time window for the identified file;
receiving in the receiver device the identified file from the broadcast transmissions;
extracting the requested UDP packets from the received file; and
passing the extracted UDP packets to the requesting application operating within the receiver device.

3. The method of claim 2, further comprising:
storing version identifying information in memory in the receiver device, the version identifying information indicating a version of the received identified file;
monitoring the broadcast scheduling message for new versions of the identified file; and
receiving in the receiver device an updated version of the identified file from the broadcast communication network when the broadcast scheduling message indicates that a new or updated version of the identified file is being broadcast.

4. The method of claim 2, wherein the file capture request is received by the receiver device in the form of commands to capture a file containing the requested UDP packets once or as a command to capture all instances of the file.

5. The method of claim 2, wherein the generated broadcast scheduling message further identifies a time when the broadcast scheduling message will be updated, the method further comprising:
broadcasting the broadcast scheduling message multiple times within the broadcast scheduling period;
deactivating receiver circuitry in the receiver device after the broadcast scheduling message has been received;
determining when the current time equals the time the broadcast scheduling message will be updated;
reactivating the receiver circuitry in the receiver device when the current time equals the time the broadcast scheduling message will be updated; and
receiving an updated broadcast scheduling message.

6. The method of claim 1, wherein the generated files are scheduled for broadcast based upon a relative urgency identified by a file ingestion system.

7. The method of claim 1, wherein the files are generated to contain UDP packets from content providers targeting users having similar demographics.

8. The method of claim 1, wherein the files are generated to contain UDP packets from content providers providing similar services.

9. The method of claim 1, wherein the files are generated to contain UDP packets from content providers providing news services.

10. The method of claim 2, wherein the application operating within the receiver device receives the UDP packets without being exposed to the delivery method used to deliver the UDP packets to the receiver device.

11. The method of claim 1, wherein:
receiving in the server of the broadcast communication network UDP packets for transport from a content provider comprises receiving in the server UDP packets from a plurality of content providers; and
generating files containing the received UDP packets in the server comprises generating a single file containing UDP packets received from at least two different content providers.

12. The method of claim 2, wherein:
extracting the requested UDP packets from the received file comprises extracting UDP packets from a plurality of content providers from the received file; and
passing the extracted UDP packets to the requesting application comprises passing selected extracted UDP packets to a plurality of requesting applications.

13. A system for delivering user datagram protocol (UDP) packets over a broadcast communication network, comprising:
means for receiving in a server of the broadcast communication network UDP packets for transport from a content provider;
means for generating files containing the received UDP packets, the generated files having a file name and containing information regarding the UDP packets contained in the files and communication requirements;
means for scheduling the generated files for transmission via a file data flow within broadcast transmission;
means for generating a broadcast scheduling message indicating when files will be broadcast within a broadcast scheduling period, information regarding those files, and a scheduled broadcast time window for each file;
means for broadcasting the generated broadcast scheduling message via the broadcast communication network; and
means for broadcasting the generated files via the file data flow of the broadcast communication network in accordance with the scheduled broadcast time windows included within the broadcast scheduling message.

14. The system of claim 13, further comprising a receiver device comprising:
means for receiving from an application operating within the receiver device a request to capture UDP packets, the request specifying one or more reception criteria;
means for receiving the broadcast scheduling message in the receiver device;
means for monitoring the broadcast scheduling message in the receiver device for a file matching the reception criteria;
means for identifying from the broadcast scheduling message the scheduled broadcast time window when a file matching the reception criteria will be broadcast;
means for activating a receiver circuitry of the receiver device at the identified scheduled broadcast time window for the identified file;
means for selecting a file for reception based upon file information in the received broadcast scheduling message;
means for receiving in the receiver device the selected file from the broadcast transmissions;
means for extracting the requested UDP packets from the received file; and
means for passing the extracted UDP packets to the requesting application operating within the receiver device.

15. The system of claim 14, further comprising:
means for storing version identifying information in memory in the receiver device, the version identifying information indicating a version of the received file;
means for monitoring the broadcast scheduling message for new versions of the received file; and
means for receiving in the receiver device an updated version of the requested file from the broadcast communication network when the broadcast scheduling message indicates that a new or updated version of the file is being broadcast.

16. The system of claim 14, wherein means for receiving the request to capture UDP packets comprises means for receiving commands to capture a file containing the requested UDP packets once or as a command to capture all instances of the file.

17. The system of claim 14, wherein means for generating a broadcast scheduling message includes means for identifying a time when the broadcast scheduling message will be updated, the system further comprising:
means for broadcasting the broadcast scheduling message multiple times within the broadcast scheduling period;
means for deactivating receiver circuitry in the receiver device after the broadcast scheduling message has been received;
means for determining when the current time equals the time the broadcast scheduling message will be updated;
means for reactivating the receiver circuitry in the receiver device when the current time equals the time the broadcast scheduling message will be updated; and
means for receiving an updated broadcast scheduling message.

18. The system of claim 13, wherein means for generating files comprises means for scheduling the generated files for broadcast based upon a relative urgency identified by a file ingestion system.

19. The system of claim 13, wherein means for generating files comprises means for generating the files to contain UDP packets from content providers targeting users having similar demographics.

20. The system of claim 13, wherein means for generating files comprises means for generating the files to contain UDP packets from content providers providing similar services.

21. The system of claim 13, wherein means for generating files comprises means for generating the files to contain UDP packets from content providers providing news services.

22. The system of claim 14, wherein the receiver device further comprises means for receiving the UDP packets without being exposed to the delivery method used to deliver the UDP packets to the receiver device.

23. The system of claim 13, wherein:
means for receiving in the server of the broadcast communication network UDP packets for transport from a content provider comprises means for receiving in the server UDP packets from a plurality of content providers; and
means for generating files containing the received UDP packets in the server comprises means for generating a single file containing UDP packets received from at least two different content providers.

24. The system of claim 14, wherein:
means for extracting the requested UDP packets from the received file comprises extracting UDP packets from a plurality of content providers from the received file; and
means for passing the extracted UDP packets to the requesting application comprises means for passing selected extracted UDP packets to a plurality of requesting applications.

25. A computer within a broadcast communication network configured to enable the broadcast communication network to transmit user datagram protocol (UDP) packets to a receiver device, comprising:
a memory; and
a processor coupled to the memory, wherein the processor is configured with processor-executable instructions to perform operations comprising:
receiving UDP packets for transport from a content provider;
generating files containing the received UDP packets, the generated files having a file name and containing information regarding the UDP packets contained in the files and communication requirements;
scheduling the generated files for transmission via a file data flow within broadcast transmissions;
generating a broadcast scheduling message indicating when files will be broadcast within a broadcast scheduling period, information regarding those files, and a scheduled broadcast time window for each file;
broadcasting the generated broadcast scheduling message via the broadcast communication network; and
broadcasting the generated files via the file data flow of the broadcast communication network in accordance with the scheduled broadcast time windows included within the broadcast scheduling message.

26. The computer of claim 25, wherein the processor-executable instructions are configured to cause the processor to perform operations such that the generated files are scheduled for broadcast based upon a relative urgency identified by a file ingestion system.

27. The computer of claim 25, wherein the processor-executable instructions are configured to cause the processor to perform operations such that the files are generated to contain UDP packets from content providers targeting users having similar demographics.

28. The computer of claim 25, wherein the processor-executable instructions are configured to cause the processor to perform operations such that the files are generated to contain UDP packets from content providers providing similar services.

29. The computer of claim 25, wherein the processor-executable instructions are configured to cause the processor to perform operations such that the files are generated to contain UDP packets from content providers providing news services.

30. The computer of claim 25, wherein the processor-executable instructions are configured to cause the processor to perform operations such that:
receiving UDP packets for transport from a content provider comprises receiving UDP packets from a plurality of content providers; and
generating files containing the received UDP packets comprises generating a single file containing UDP packets received from at least two different content providers.

31. A computer within a broadcast communication network configured to enable the broadcast communication network to transmit user datagram protocol (UDP) packets to a receiver device, comprising:
means for receiving UDP packets for transport from a content provider;
means for generating files containing the received UDP packets, the generated files having a file name and containing information regarding the UDP packets contained in the files and communication requirements;
means for scheduling the generated files for transmission via a file data flow within broadcast transmissions;
means for generating a broadcast scheduling message indicating when files will be broadcast within a broadcast scheduling period, information regarding those files, and a scheduled broadcast time window for each file;
means for broadcasting the generated broadcast scheduling message via the broadcast communication network; and
means for broadcasting the generated files via the file data flow of the broadcast communication network in accordance with the scheduled broadcast time windows included within the broadcast scheduling message.

32. The computer of claim 31, wherein means for scheduling the generated files for transmission comprises means for scheduling the generated files for transmission based upon a relative urgency identified by a file ingestion system.

33. The computer of claim 31, wherein means for generating files containing the received UDP packets comprises means for generating files containing UDP packets from content providers targeting users having similar demographics.

34. The computer of claim 31, wherein means for generating files containing the received UDP packets comprises means for generating files containing UDP packets from content providers providing similar services.

35. The computer of claim 31, wherein means for generating files containing the received UDP packets comprises means for generating files containing UDP packets from content providers providing news services.

36. The computer of claim 31, wherein:
means for receiving UDP packets for transport from a content provider comprises means for receiving UDP packets from a plurality of content providers; and
means for generating files containing the received UDP packets comprises means for generating a single file containing UDP packets received from at least two different content providers.

37. A non-transitory computer-readable storage medium having stored thereon computer-executable software instructions configured to cause a computer within a broadcast communication network to perform operations comprising:
receiving user datagram protocol (UDP) packets for transport from a content provider;
generating files containing the received UDP packets, the generated files having a file name and containing information regarding the UDP packets contained in the files and communication requirements;
scheduling the generated files for transmission via a file data flow within broadcast transmission;
generating a broadcast scheduling message indicating when files will be broadcast within a broadcast scheduling period, information regarding those files, and a scheduled broadcast time window for each file;
broadcasting the generated broadcast scheduling message via the broadcast communication network; and
broadcasting the generated files via the file data flow of the broadcast communication network in accordance with the scheduled broadcast time windows included within the broadcast scheduling message.

38. The non-transitory computer-readable storage medium of claim 37, wherein the computer-executable software instructions are configured to cause the computer to perform operations such that the generated broadcast scheduling message further identifies a time when the broadcast scheduling message will be updated, the stored computer-executable software instructions being further configured to cause the computer to perform operations comprising:
broadcasting the broadcast scheduling message multiple times within the broadcast scheduling period.

39. The non-transitory computer-readable storage medium of claim 37, wherein the stored computer-executable software instructions are configured to cause the computer to perform operations such that the generated files are scheduled for broadcast based upon a relative urgency identified by a file ingestion system.

40. The non-transitory computer-readable storage medium of claim 37, wherein the stored computer-executable software instructions are configured to cause the computer to perform operations such that the files are generated to contain UDP packets from content providers targeting users having similar demographics.

41. The non-transitory computer-readable storage medium of claim 37, wherein the stored computer-executable software instructions are configured to cause the computer to perform operations such that the files are generated to contain UDP packets from content providers providing similar services.

42. The non-transitory computer-readable storage medium of claim 37, wherein the stored computer-executable software instructions are configured to cause the computer to perform operations such that the files are generated to contain UDP packets from content providers providing news services.

43. The non-transitory computer-readable storage medium of claim 37, wherein the stored computer-executable software instructions are configured to cause the computer to perform operations such that:
receiving UDP packets for transport from a content provider comprises receiving UDP packets from a plurality of content providers; and
generating files containing the received UDP packets comprises generating a single file containing UDP packets received from at least two different content providers.

44. A receiver device for receiving user datagram protocol (UDP) packets from a broadcast communication network, comprising:
receiver circuitry;
a memory; and
a processor coupled to the memory, wherein the processor is configured with processor-executable instructions to perform operations comprising:
receiving from an application operating within the receiver device a request to capture UDP packets, the request specifying one or more reception criteria;
receiving a broadcast scheduling message;
identifying for reception a file containing UDP packets matching the reception criteria based on information in the received broadcast scheduling message;
identifying from the broadcast scheduling message a scheduled broadcast time window when the identified file containing UDP packets matching the reception criteria will be broadcast;
activating receiver circuitry of the receiver device at the identified scheduled broadcast time window for the identified file;
receiving the identified file from the broadcast transmissions;
extracting the requested UDP packets from the received file; and
passing the extracted UDP packets to the requesting application.

45. The receiver device of claim 44, wherein the processor is further configured with processor-executable instructions to perform operations comprising:
storing version identifying information in the memory, the version identifying information indicating a version of the received identified file;
monitoring the broadcast scheduling message for new versions of the identified file; and
receiving an updated version of the identified file from the broadcast communication network when the broadcast scheduling message indicates that a new or updated version of the identified file is being broadcast.

46. The receiver device of claim 44, wherein the processor is further configured with processor-executable instructions to perform operations such that the file capture request is received by the receiver device in the form of commands to capture a file containing the requested UDP packets once or as a command to capture all instances of the file.

47. The receiver device of claim 44, wherein the processor is further configured with processor-executable instructions to perform operations comprising:
extracting a time when the broadcast scheduling message will be updated from the broadcast scheduling message;
deactivating the receiver circuitry after the broadcast scheduling message has been received;
determining when current time equals the time the broadcast scheduling message will be updated;
reactivating the receiver circuitry when the current time equals the time the broadcast scheduling message will be updated; and
receiving an updated broadcast scheduling message.

48. The receiver device of claim 44, wherein the processor is further configured with processor-executable instructions to perform operations such that the application operating within the receiver device receives the UDP packets without being exposed to the delivery method used to deliver the UDP packets to the receiver device.

49. The receiver device of claim 44, wherein the processor is further configured with processor-executable instructions to perform operations such that:
extracting the requested UDP packets from the received file comprises extracting UDP packets from a plurality of content providers from the received file; and
passing the extracted UDP packets to the requesting application comprises passing the extracted UDP packets to a plurality of requesting applications.

50. A receiver device for receiving user datagram protocol (UDP) packets from a broadcast communication network, comprising:
means for receiving from an application operating within the receiver device a request to capture UDP packets, the request specifying one or more reception criteria;
means for receiving a broadcast scheduling message;
means for identifying for reception a file containing UDP packets matching the reception criteria based on information in the received broadcast scheduling message;
means for identifying from the broadcast scheduling message a scheduled broadcast time window when a file matching the reception criteria will be broadcast;
means for activating a receiver circuitry of the receiver device at the identified scheduled broadcast time window for the identified file;
means for receiving the identified file from the broadcast transmissions;
means for extracting the requested UDP packets from the received file; and
means for passing the extracted UDP packets to the requesting application.

51. The receiver device of claim 50, further comprising:
means for storing version identifying information in memory, the version identifying information indicating a version of the received identified file;
means for monitoring the broadcast scheduling message for new versions of the identified file; and
means for receiving an updated version of the identified file from the broadcast communication network when the broadcast scheduling message indicates that a new or updated version of the identified file is being broadcast.

52. The receiver device of claim 50, wherein means for receiving from an application operating within the receiver device a request to capture UDP packets comprises means for receiving from an application operating within the receiver device a request to capture UDP packets in the form of commands to capture a file containing the requested UDP packets once or as a command to capture all instances of the file.

53. The receiver device of claim 50, further comprising:
means for extracting a time when the broadcast scheduling message will be updated from the broadcast scheduling message;
means for deactivating the receiver circuitry after the broadcast scheduling message has been received;
means for determining when current time equals the time the broadcast scheduling message will be updated;
means for reactivating the receiver circuitry when the current time equals the time the broadcast scheduling message will be updated; and
means for receiving an updated broadcast scheduling message.

54. The receiver device of claim 50, wherein means for passing the extracted UDP packets to the requesting application comprise means for passing the extracted UDP packets to the requesting application without exposing the application to the delivery method used to deliver the UDP packets to the receiver device.

55. The receiver device of claim 50, wherein:
means for extracting the requested UDP packets from the received file comprises means for extracting UDP packets from a plurality of content providers from a single received file; and
means for passing the extracted UDP packets to the requesting application comprises means for passing the extracted UDP packets to a plurality of requesting applications.

56. A non-transitory processor-readable storage medium having stored thereon processor-executable software instructions configured to cause a processor within a receiver device to perform operations comprising:
receiving from an application operating within the receiver device a request to capture user datagram protocol (UDP) packets, the request specifying one or more reception criteria;
receiving a broadcast scheduling message;
identifying for reception a file containing UDP packets matching the reception criteria based on information in the received broadcast scheduling message;
identifying from the broadcast scheduling message a scheduled broadcast time window when a file matching the reception criteria will be broadcast;
activating a receiver circuitry of the receiver device at the identified scheduled broadcast time window for the identified file;
receiving the identified file from the broadcast transmissions;
extracting the requested UDP packets from the received file; and
passing the extracted UDP packets to the requesting application operating within the receiver device.

57. The non-transitory processor-readable storage medium of claim 56, wherein the stored processor-executable software instructions are further configured to cause the processor to perform operations further comprising:
deactivating the receiver circuitry of the receiver device after the broadcast scheduling message has been received;
determining when current time equals a time the broadcast scheduling message will be updated;
reactivating the receiver circuitry of the receiver device when the current time equals the time the broadcast scheduling message will be updated; and
receiving an updated broadcast scheduling message.

58. The non-transitory processor-readable storage medium of claim 56, wherein the stored processor-executable software instructions are further configured to cause the processor to perform operations further comprising:
storing version identifying information in memory, the version identifying information indicating a version of the received identified file;
monitoring the broadcast scheduling message for new versions of the identified file; and
receiving an updated version of the identified file from the broadcast communication network when the broadcast scheduling message indicates that a new or updated version of the identified file is being broadcast.

59. The non-transitory processor-readable storage medium of claim 56, wherein the stored processor-executable software instructions are configured to cause the processor to perform operations such that receiving from an application operating within the receiver device a request to capture user datagram protocol (UDP) packets comprises receiving a request in the form of commands to capture a file containing the requested UDP packets once or as a command to capture all instances of the file.

60. The non-transitory processor-readable storage medium of claim 56, wherein the stored processor-executable software instructions are configured to cause the processor to perform operations such that the application operating within the receiver device receives the UDP packets without being exposed to the delivery method used to deliver the UDP packets to the receiver device.

61. The non-transitory processor-readable storage medium of claim 56, wherein the stored processor-executable software instructions are configured to cause the processor to perform operations such that:
extracting the requested UDP packets from the received file comprises extracting UDP packets from a plurality of content providers from the received file; and
passing the extracted UDP packets to the requesting application comprises passing the extracted UDP packets to a plurality of requesting applications.
